(19) United States
(12) Patent Application Publication
(10) Pub. No.: US 2020/0210906 A1
(43) Pub. Date: Jul. 2, 2020

(54) EVENT-BASED SERVICE ENGINE AND SYSTEM

(71) Applicant: AT&T Intellectual Property I, L.P., Atlanta, GA (US)

(72) Inventors: Mitchell Rice, Dunwoody, GA (US); Dale Malik, Atlanta, GA (US); Mark Olsen, Alpharetta, GA (US)

(21) Appl. No.: 16/234,361

(22) Filed: Dec. 27, 2018

(51) Int. Cl. G06Q 10/02; G06F 21/62; G06N 20/00

(52) U.S. Cl. CPC G06Q 10/025; G06N 20/00; G06F 21/6254

(57) ABSTRACT

Methods are disclosed for providing a connected context based experience to a user during a traveling event. A processing system including a processor detects a start of a traveling event for a user, establishes a context data sharing community for the traveling event, wherein the context data sharing community comprises at least one context data source device and a plurality of service agents, where each service agent is expected to provide a service to the user for a duration specified for the traveling event, determines at least one recommendation or at least one action from context data associated with the user received from the at least one context data source device, wherein the context data comprises a purpose of the user for the traveling event, and provides the at least one recommendation to at least one service agent of the plurality of service agents for presentation to the user.

The present disclosure relates generally to an event based service engine and system, and more particularly to methods, computer-readable media, and processing systems for using machine learning for providing a connected context based experience to a user during a traveling event.

### BACKGROUND

Various information systems may involve the use of data to implement actions for a user to achieve a particular purpose. For example, a hotel reservation system may account for a user's preference in reserving a hotel room. Similarly, an airline system may account for a user's preference in reserving a flight to a destination. Unfortunately, such systems are not scalable and are not integrated in any way to account for the context with which the hotel room and the airline flight are being used. As such, users are often left to their own devices to continually engage various different systems to gain access to services while on the move, e.g., during a traveling event.

### SUMMARY

In one example, the present disclosure describes a method, computer readable medium, and processing system for providing a connected context based experience to a user during a traveling event. For example, a processing system including at least one processor detects a start of a traveling event for a user, and establishes a first context data sharing community for the traveling event, wherein the first context data sharing community comprises at least one context data source device and a plurality of service agents, where each of the plurality of service agents is expected to provide at least one service to the user for a duration specified for the traveling event. The processing system determines at least one recommendation or at least one action from context data associated with the user received from the at least one context data source device, wherein the context data comprises a purpose of the user for the traveling event, and provides the at least one recommendation to at least one service agent of the plurality of service agents for presentation to the user.

### BRIEF DESCRIPTION OF THE DRAWINGS

The teaching of the present disclosure can be readily understood by considering the following detailed description in conjunction with the accompanying drawings, in which:

FIG. 1 illustrates an example system related to the present disclosure;

FIG. 2 illustrates an example event based service system, according to the present disclosure;

FIG. 3 illustrates a flowchart of an example method for providing a connected context based experience to a user during a traveling event, in accordance with the present disclosure;

FIG. 4 illustrates a flowchart of an example method of a service agent for assisting in providing a connected context based experience to a user during a traveling event, in accordance with the present disclosure; and

FIG. 5 illustrates an example high-level block diagram of a computing device specifically programmed to perform the steps, functions, blocks, and/or operations described herein.

To facilitate understanding, identical reference numerals have been used, where possible, to designate identical elements that are common to the figures.

### DETAILED DESCRIPTION

Various information systems may involve the use of data to implement actions for a user to achieve a particular purpose. For example, a user in planning for a trip may utilize a hotel reservation system to reserve a hotel room, an airline system to book a flight for the trip, or a rental car system to arrange for a rental car upon arriving at the airport. Although such systems may account for the user's preferences in reserving the hotel room (e.g., the type of room to be reserved), the airline flight (e.g., the time of the flight or the seating on the aircraft) or the rental car (e.g., the type of rental car), such systems are not integrated in any way to account for the context for which the user is taking the trip in the first place. The context pertains to the “purpose,” “reason,” or “intent” of the trip, i.e., why is the user taking the trip. For example, the user may be traveling for business reasons or for personal reasons, and so on. More explicitly, the purpose can be further defined in a finer granularity, e.g., if the user is traveling for business reasons, then the business reasons can be further quantified such as: 1) traveling to visit a client, 2) traveling to a trade show, 3) traveling to attend a seminar for work, 4) traveling to visit a co-worker in another branch office of the user's company, 5) traveling to fix a problem at a site of a customer, 6) traveling to attend a technical meeting for a standard making body, 7) traveling to inspect a manufacturing facility, 8) traveling to determine a potential new office site for the user's company, 9) traveling to recruit new hires for the user's company, and so on. Similarly, if the user is traveling for personal reasons, then the personal reasons can also be further quantified such as: 1) traveling for vacation, 2) traveling to visit a family member, 3) traveling for medical reasons, e.g., treatment or consultation, 4) traveling to attend a wedding, 5) traveling for touring potential colleges to attend, 6) traveling due to study abroad for a college degree, 7) traveling to interview for a new job, and so on. Such rich context information are not utilized, not available, or not even utilized when accessible by information systems that are encountered by the users during the trip.

In other words, although information systems can be used to make reservations, such systems do not account for the context information. Second, such information systems do not track the user as the user starts on the traversal of the trip, i.e., the systems do not track the progression of the user at different stages of the trip. Finally, such systems are not integrated, i.e., any interactions with the user by each system is not reported to any other systems that the user may encounter during different stages of the trip. As such, users are often left to their own devices to continually engage various different systems to gain access to services while on the move, e.g., during different stages of a trip (broadly a traveling event). For example, a user may arrange on the user's smart phone for a ride (e.g., a taxi, a limousine, or a rideshare such as Lyft™, or Uber™) to the airport at the start of the trip. The user may then check in with the airline on the user's smart phone upon arrival at the airport. The user may then check in with the rental car company on the user's smart phone upon landing at the destination airport. The user may then check in with the hotel on the user's smart phone while leaving the destination airport to ensure the hotel room is still reserved for the user. The user may then use the user's smart phone to search for a restaurant or other entertainment options after checking into the hotel, and so on. This illustrative example demonstrates the continual need of the user to actively start and engage different information systems and/or software applications at different stages of the trip.

Examples of the present disclosure employ machine learning for providing a connected context based experience to a user during a traveling event. In particular, a context data sharing platform is trained via machine learning to interact with one or more service agents of various systems (e.g., third party service provider systems) to provide a dynamic event based experience where recommendations and/or actions are presented to or taken on behalf of the user during different stages of the traveling event. For example, the context data sharing platform may serve as an online concierge that dynamically and continuously monitors the user's progression during a traveling event and then presents recommendations and/or take actions for the user during different stages of the traveling event.

A service agent is broadly defined as a third party software application or instantiation (e.g., deployed on a hardware screen with a processing element) that a user can interact with during the traveling event. For example, a user may interact with a screen with a service agent such as: 1) during a transportation stage of the trip, e.g., the screen in front of an airline seat, the screen in front of a train seat, or the screen in a taxi or rideshare vehicle; 2) during a check-in stage, e.g., the screen on a kiosk at the airport, at the rental car company, at the hotel lobby, at a stadium, at a theater, or at a convention venue; or 3) during an activity stage of the trip, e.g., the screen at a restaurant table during a meal activity, the screen at a conference room during a meeting activity, or the screen (e.g., the user's own smart phone screen) during a communication activity (e.g., sending a text or email message on the smart phone, talking on the smart phone, consuming multimedia on the smart phone, or accessing the Internet on the smart phone), and so on.

In one example embodiment, the context data sharing platform comprises one or more components, e.g., a profile collector, a decision analyzer, and an action delivery system. In one embodiment, the context data sharing platform is implemented with the use of machine learning.

For example, the profile collector component may receive, organize and/or store contextual data that are received from one or more context data source devices, e.g., service agents can be both a consumer and a generator of context data for a user. For example, a service agent at the rental car company may report the data that the user voluntarily upgraded from a previously reserved small car to a much larger vehicle, e.g., a minivan. This data may allow the context data sharing platform to postulate the context data that the user is anticipating to carry a larger group of travelers and/or to carry a larger cargo load. Similarly, for example, a service agent at the airline may report the data that the user is delayed due to the user having missed his connecting flight and is currently on another later connecting flight, thereby causing the user to arrive at the final destination airport at 10:00 pm instead of 5:00 pm. This data may allow the context data sharing platform to postulate the context data that the user is likely interested in canceling or adjusting various previously arranged activities, e.g., canceling a meeting appointment, adjusting a dinner reservation, notifying a hotel of a late check-in, and so on. Receiving and accumulating such data allows the context data sharing platform to deduce context data and to better assist the user.

Furthermore, in one example, the profile collector may implement a sub-component called the “profile builder,” which attempts to improve on the accuracy of the received contextual data. For example, the profile collector may generate one or more questions to ask the users to assist in improving and refining the details of the context that the users are currently in. In one embodiment, these questions are not limited to the initial profile setup as a user is registered with the system, but also include questions that are generated and presented to the user at each stage (e.g., at the beginning, during or end of the stage) of the traveling event to inquire as to the effectiveness of the recommendations and actions acted on by the context data sharing platform. For example, during initial profile setup the following questions may be presented to the users: 1) “If your transportation stage is delayed, do you want the system to arrange a change of the prearranged activities, e.g., changing a restaurant reservation if your flight is delayed?,” 2) “Do you want the system to arrange a cancellable back-up reservation for your check-in stage, e.g., always make another commensurate hotel reservation that is comparable in cost, quality and location in relation to a current hotel reservation?,” 3) “Do you want the system to arrange a cancellation call for a particular type of registered event for your activity stage if your current travel time indicates that you will miss the registered event by a certain amount of time, e.g., 45 minutes late for a golf tee time?,” and so on. In another example, during a particular stage of travel the following questions may be presented to the users: 1) “Was changing the restaurant reservation from 6:00 pm to 7:30 pm due to your delayed flight appropriate?,” 2) “Was canceling the restaurant reservation scheduled for 7pm and ordering a vegan entrée to be delivered to your hotel instead due to your delayed flight arriving at 10pm appropriate?,” 3) “Was requesting a video conferencing bridge information for an in-person meeting due to your delayed flight appropriate?,” and so on. Answers to such questions will allow the context data sharing platform with the help of machine learning to better understand and serve the user over time.

In one embodiment, the decision analyzer uses machine learning to determine the current context for a user who is interacting with a particular service agent, and will determine a set of actions or recommendations that can be taken or presented by that particular service agent based on that context. To illustrate, in one example, if a user is traveling in a rideshare vehicle that has a service agent (e.g., Lyft™, Uber™, etc.) to a movie theater to watch a movie scheduled for a designated time (e.g., 5 pm) and the user is likely to arrive late and will miss the movie previews, then the decision analyzer may determine one or more actions such as: 1) presenting the movie previews for the user to watch via the service agent in the rideshare vehicle, 2) asking if the user would like to purchase the movie ticket before arriving at the movie theater, or 3) showing available reservations (e.g., between 7 pm-9 pm) for nearby restaurants for after the movie, etc.

In one embodiment, the action delivery system may execute an action presented by the decision analyzer. For example, if the decision analyzer indicates that movie previews should be presented by the service agent in the rideshare vehicle, then the action delivery system will either obtain the movie previews (e.g., from a website of the movie theater that offers viewing of its movie previews) and forward the movie previews to the service agent in the rideshare vehicle, or the action delivery system may simply direct the service agent in the rideshare vehicle to obtain the pertinent movie previews on its own. In one embodiment, results of the action taken by the action delivery system (e.g., whether the user utilized the product(s) or service(s) of the taken action) are also sent back to the decision analyzer to further improve the machine learning model used by the context data sharing platform. This allows the action delivery system to continually implement relevant actions with the service agent(s) depending on the current context.

In one example, one or more context sharing communities can be established for one or more service agents for each user. For example, a user may want to set limits as to the level of integration between various service agents. For example, a user may only want “travel related” service agents to be connected, e.g., an airline service agent may be allowed to interact with a car rental service agent located at the destination airport, or a hotel service agent may be allowed to interact with a food service delivery service agent for delivering food to a hotel customer and so on. In another example, a user may be uncomfortable that a service agent for a rideshare vehicle is able to interact with other service agents that the user will be interacting with during the traveling event. Since the driver of the rideshare vehicle is a stranger to the user, the user may not want to allow the service agent in the rideshare vehicle to gain knowledge of the user's travel plan. As such, in one example the user is allowed to dynamically define the membership of the one or more context sharing communities and the permission level as to what portions of the context data can be accessed by each service agent of a plurality of service agents.

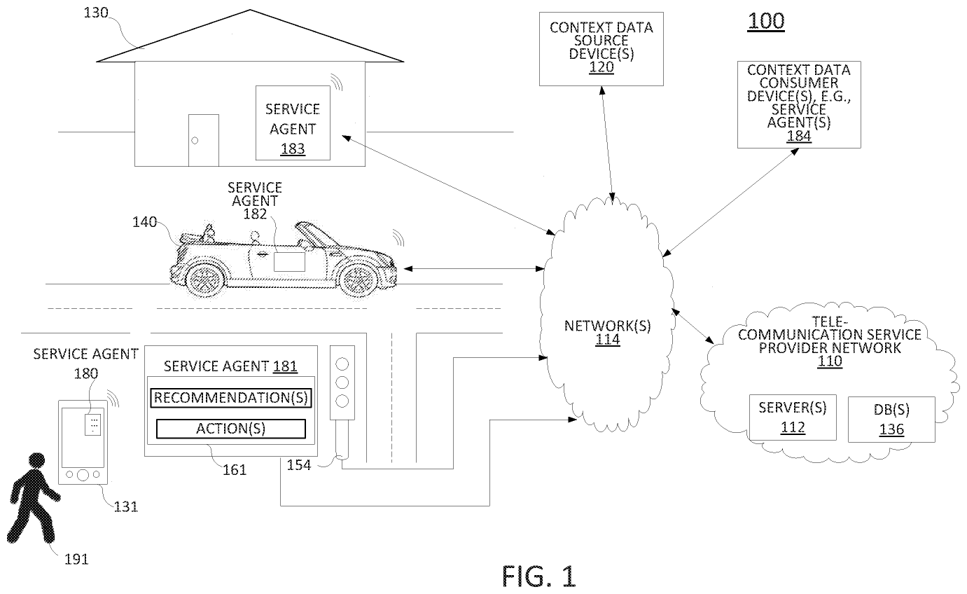

Furthermore, in addition to which service agents are allowed membership to the one or more context sharing communities, the user may also specify the types of context data that can be shared among the service agents of a particular context data sharing community. For example, the user may allow context data pertaining to food preferences to be freely shared among the service agents, whereas context data pertaining to why a user is at certain location may be limited to those service agents with innate service functions that require such location information to function properly, e.g., a rideshare or navigation service agent, and whereas context data pertaining to user communication is strictly regulated, e.g., a service agent must be individually authorized before context data pertaining to user communication is made available (e.g., a service agent located on the user's smart phone may be allowed to know why the user is sending a text message to the user's spouse, e.g., upon landing at the destination airport, but the service agent for a rideshare vehicle would not be authorized to receive such context data). These and other aspects of the present disclosure are discussed in greater detail below in connection with the examples of FIGS. 1-5.

To aid in understanding the present disclosure, FIG. 1 illustrates a block diagram depicting one example of an environment 100 suitable for performing or enabling the steps, functions, operations, and/or features described herein. As illustrated in FIG. 1, the environment 100 includes a telecommunication service provider network 110. In one example, telecommunication service provider network 110 may comprise a core network, a backbone network or transport network, such as an Internet Protocol (IP)/multi-protocol label switching (MPLS) network, where label switched routes (LSRs) can be assigned for routing Transmission Control Protocol (TCP)/IP packets, User Datagram Protocol (UDP)/IP packets, and other types of protocol data units (PDUs), and so forth. It should be noted that an IP network is broadly defined as a network that uses Internet Protocol to exchange data packets. However, it will be appreciated that the present disclosure is equally applicable to other types of data units and transport protocols, such as Frame Relay, and Asynchronous Transfer Mode (ATM). In one example, the telecommunication service provider network 110 uses a network function virtualization infrastructure (NFVI), e.g., host devices or servers that are available as host devices to host virtual machines comprising virtual network functions (VNFs). In other words, at least a portion of the telecommunication service provider network 110 may incorporate software-defined network (SDN) components.

In one example, telecommunication service provider network 110 is connected to networks 114. The networks 114 may include a wireless access network (e.g., an IEEE 802.11/Wi-Fi network and the like), a Wide Area Network (WAN), a cellular access network, such a Universal Mobile Telecommunications System (UMTS) terrestrial radio access network (UTRAN), an evolved UTRAN (eUTRAN), a base station subsystem (BSS), e.g., a Global System for Mobile communication (GSM) radio access network (GRAN), a 2G, 3G, 4G and/or 5G network, a Long Term Evolution (LTE) network, and the like), a circuit switched network (e.g., a public switched telephone network (PSTN)), a cable access network, a digital subscriber line (DSL) network, a metropolitan area network (MAN), other types of wired access networks, an Internet service provider (ISP) network, and the like. Alternatively, or in addition, networks 114 may represent enterprise networks, corporate, governmental, or educational institution LANs, a home/residential LAN, and the like. In one embodiment, the networks 114 may all be different types of networks, may all be the same type of network, or some networks may be of a same type and others may be different types of networks. The networks 114 and the telecommunication service provider network 110 may be operated by different service providers, the same service provider, or a combination thereof. For instance, in an example where networks 114 include a cellular access network, telecommunication service provider network 110 may include evolved packet core (EPC) network components, network switching subsystem (NSS)/GSM core network and/or General Packet Radio Service (GPRS) core network components, and so forth. The networks 114 (e.g., access networks) and the telecommunication service provider network 110 may be interconnected via one or more intermediary networks (not shown) which may utilize various different protocols and technologies for transporting communications in the form of data packets, datagrams, protocol data units (PDUs), and the like, such as one or more IP/MPLS networks, one or more frame relay networks, one or more ATM networks, and so forth. In one example, the networks 114 may represent the Internet in general.

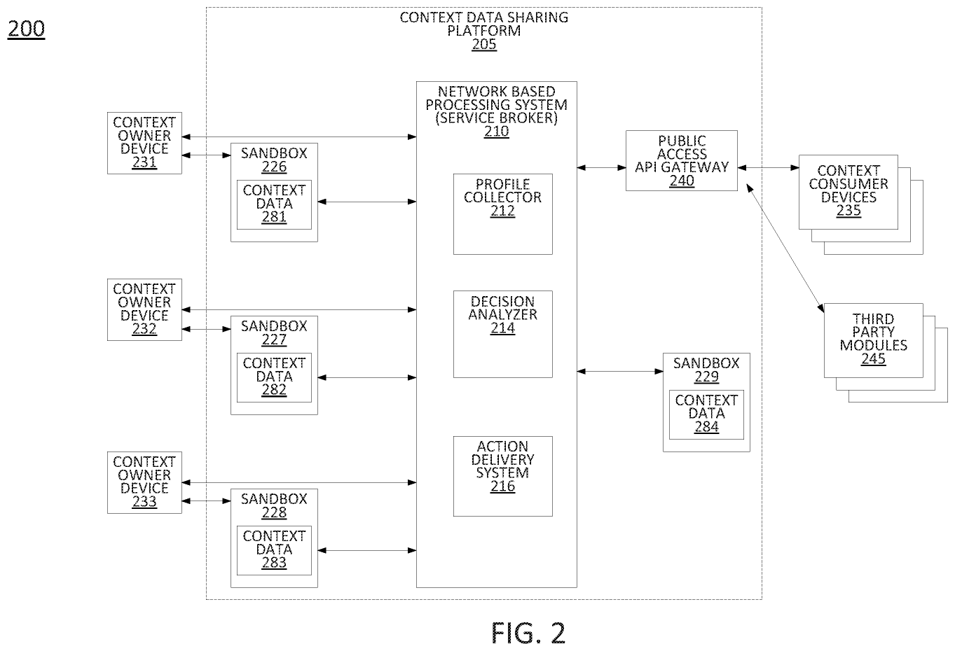

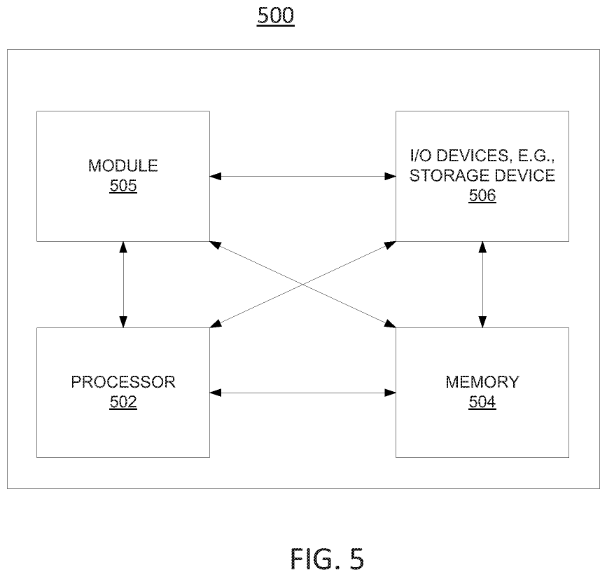

Further illustrated in FIG. 1 is one or more servers 112 in telecommunication service provider network 110. The server(s) 112 may each comprise all or a portion of a computing device or system, such as computing system 500, and/or processing system 502 as described in connection with FIG. 5 below, specifically configured to perform various steps, functions, and/or operations for establishing a context data sharing community for a traveling event, as described herein. For example, one of the server(s) 112, or a plurality of servers 112 collectively, may perform operations in connection with the example method 300 or 400, or as otherwise described herein. In one example, the one or more servers 112 may comprise a context data sharing platform 205, as described in greater detail below in connection with the example system 200 of FIG. 2.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIGS. 5 and discussed below) or multiple computing devices collectively configured to perform various steps, functions, and/or operations in accordance with the present disclosure.

In one example, telecommunication service provider network 110 may also include one or more databases (DBs) 136, e.g., physical storage devices integrated with server(s) 112 (e.g., database servers), attached or coupled to the server(s) 112, and/or in remote communication with server(s) 112 to store various types of information in support of systems providing a connected context based experience to a user during a traveling event, as described herein. In one example, server(s) 112 and/or DB(s) 136 may comprise cloud-based and/or distributed data storage and/or processing systems comprising one or more servers at a same location or at different locations. For instance, DB(s) 136, or DB(s) 136 in conjunction with one or more of the servers 112, may represent a distributed file system, e.g., a Hadoop® Distributed File System (HDFS™), or the like. In one example, DB(s) 136 in conjunction with one or more of the servers 112, may comprise a context data sharing platform 205, as described in greater detail below in connection with the example system 200 of FIG. 2.

In one example, DB(s) 136 may receive and store context data from a variety of different context data sources. For example, the context data sources may include service agents 180-183, various sensor(s) 154 (e.g., deployed on traffic lights or traffic signals), context data source devices 120, context data consumer devices 184 (which could be implemented as service agents as well), and so forth. To illustrate, DB(s) 136 may receive information feeds from one or more context data source device(s) 120, such as a location or presence server associated with a user's cellular service, a social network server that a user has a social network account, a calendar service server associated with a user's employer, and so on. The information feeds may be in formats such as a SMS/text message-based feed, a RSS feed, an email-based feed, and so forth. The information feeds received by DB(s) 136 may all be in a same format or may be in a plurality of different formats.

For example, a user may have a cellular service such that the user has authorized the cellular service provider to provide context data, e.g., the user's current location information and/or the user's communication history (e.g., types of communication at different locations), on a continual basis to the present context data sharing platform 205. Similarly, a user may have a social network account (e.g., Facebook™, Twitter™, etc.) such that the user has authorized the social network provider to provide context data, e.g., the user's travel plan or travel postings, on a continual basis to the present context data sharing platform 205. Similarly, a user may have a work calendar service such that the user has authorized the work calendar service to provide context data, e.g., the travel events listed on user's calendar, on a continual basis to the present context data sharing platform 205.

In one example, various sensors 154 (e.g., RF receivers, cameras, IR receivers and the like) may be deployed in various public locations, e.g., on a traffic light, on a street light, on a toll plaza, on buildings, on WiFi access points, on automated drones, and the like. Such sensors may have the ability to interact with a user mobile endpoint device 131, e.g., a smart phone, to detect the user's presence. If authorized by the user, such sensors may provide context data, e.g., location or presence information, captured audio information, captured video information, captured still image information, and the like, on a continual basis to the present context data sharing platform 205.

In one example, various service agents 180-183 may be deployed in various locations. In one instance, the user's own endpoint device 131, e.g., a smart phone, a laptop, a tablet computer and the like, may employ a service agent 180. The service agent 180 can be used by the user 191 to interact with the present context data sharing platform 205 while traveling on a trip. Similarly, the service agent 180 may interact with various service agents 181-183 during the trip. For example, service agents 181 and 183 may be deployed in a screen on a kiosk located at the airport, at the rental car company, at the hotel lobby, at a stadium, at a theater, at a convention venue, and so on. Alternatively, a service agent 182 may be deployed in a screen on a moving platform, e.g., a vehicle 140 such as a car, a train, an airplane, a ship and so on. In one embodiment, the service agent 181 illustrates various recommendations and actions that can be presented to the user or taken on behalf of the user. The recommendations may comprise presenting: 1) airline reservation/cancelation recommendation, 2) taxi or rideshare reservation/cancelation recommendation, 3) hotel reservation/cancelation recommendation, 4) restaurant reservation/cancelation recommendation, or 5) activity reservation/cancelation recommendation, such as reserving a golf tee time, ordering tickets for a theater, a show, a concert, or a sports event, and so on. Similarly, the actions may comprise fulfilling any one or more of the above presented recommendations upon receipt of one or more user selections or input. Furthermore, in one embodiment the action may comprise presenting a multimedia stream (e.g., audio stream, video stream, and the like) to the user and so on.

In one embodiment, the system may comprise context data consumer devices 184. In one embodiment, the context data consumer devices 184 may comprise service agents that the users may encounter during the traveling event. This will allow the service agents to better provide relevant recommendations and perform appropriate actions on behalf of the user. However, there may be context data consumer devices 184 that are not service agents that the user will encounter during the traveling event. For example, a social network server may benefit from context data associated with the user to perform other actions for the user, e.g., to better assist the user in posting travel blogs during the traveling event and so on. Similarly, a grocery ordering server may benefit from context data associated with the user to perform other actions for the user, e.g., to better assist the user in managing grocery orders during the traveling event (e.g., temporarily stop reordering of food items to be delivered while user is traveling) and so on.

In one example, a template for a context data sharing community for a traveling event may be created by agreement among the various context source and consumer parties and may be stored by DB(s) 136. A template for a context data sharing community may include such thing as: at least one trigger condition for the traveling event, a duration of time associated with a detection of the at least one trigger condition for which context data from the plurality of context data source devices is shareable, the types or fields of context data which are shareable in connection with the traveling event, permission levels for different portions of context data that are shareable in connection with the traveling event, a retention time period for retaining the gathered context data, an expiration condition for the context data sharing community, and so forth.

In one example, the template may identify one or more conditions for ending a context data sharing community for a traveling event. For instance, a first condition may specify a predefined duration of time, e.g., a maximum duration, of the context data sharing community for a traveling event, e.g., 12 hours, 24 hours, 48 hours, one week, two weeks, or the actual full duration of the traveling event from the start (e.g., leaving home) to the end (e.g., arriving home), etc. A second condition may specify that certain participants or members in the context data sharing community may send an instruction to server(s) 112 to end the context data sharing community. For instance, a social network provider may be permitted to withdraw from the context data sharing community. In still another example, the context data sharing community may end when the traveling event comes to an end or when the user indicates that the context data sharing community should be ended irrespective as to the conclusion of the traveling event.

The parties may include owners (broadly to include any entities or representatives authorized to act on behalf of the owners such as operators) of the context data source devices, such as an owner of any one of: the service agents 180-183, the context data source devices 120, the sensor(s) 154, the context data consumer devices 184, and the context data sharing platform 205. Thus, a template for a context data sharing community is created and may become active in the context data sharing platform when agreed to by the various parties. Any one or more of the parties may define the characteristics of the template for the context data sharing community and provide the characteristics to DB(s) 136 and/or server(s) 112 for storage and/or for activation of filtering for traveling event detection and context data sharing community creation.

In one example, traveling event detection may comprise the use of machine learning algorithms (MLAs) trained on context data from one or more context data sources to identify a traveling event. For instance, a traveling event detection module may detect the user traveling to and from work, traveling on a business trip, traveling on vacation, traveling to visit family during the holiday season and so on. For example, such detection can utilize location information such as global positioning system (GPS) information reported by a mobile device, e.g., a smart phone, of the user.

In one example, the one or more traveling event detection modules or filters (e.g., based on traveling event signatures) may be deployed by server(s) 112 to detect traveling events based upon context data received from any one or more context data source devices. In one example, the server(s) 112 may process the context data from context data source device(s) 120 before storing the context data in DB(s) 136. Alternatively, or in addition, the server(s) 112 may apply the traveling event detection modules or filters to the context data already stored in DB(s) 136.

In an illustrative example, a traveling event detection filter may be deployed for identifying the start of a traveling event. However, it should be understood that the traveling event may be detected in any number of ways using context data from any one or more context data sources, e.g., from postings from a social network account of the user indicating that the user is traveling on a business trip, from alerts from a work calendar application of the user, and so on. In fact, in one embodiment, the user may simply input the start of the traveling event via the service agent 180 located on the user's mobile device 131.

It should be noted that the environment 100 has been simplified. In other words, the environment 100 may be implemented in a different form than that illustrated in FIG. 1. For example, the environment 100 may be expanded to include additional networks, and additional network elements (not shown) such as wireless transceivers and/or base stations, border elements, routers, switches, policy servers, security devices, gateways, a network operations center (NOC), a content distribution network (CDN) and the like, without altering the scope of the present disclosure. In addition, environment 100 may be altered to omit various elements, substitute elements for devices that perform the same or similar functions and/or combine elements that are illustrated as separate devices.

As just one example, the operations described above with respect to server(s) 112 may alternatively or additionally be performed by a device, or a plurality of devices coupled to network(s) 114. In one example, a first device may process data from context data source devices to detect a trigger condition for a traveling event, a second device may create a context data sharing community in accordance with the template as discussed above, a third device may collect context data from data sources, and so forth. Thus, these and other modifications are all contemplated within the scope of the present disclosure.

FIG. 2 illustrates an example event based service system 200 including a context data sharing platform 205 (e.g., a network-based context data sharing platform). In one example, the context data sharing platform 205 includes a network based processing system 210, e.g., a server or multiple servers collectively configured to perform various steps, functions, and/or operations in accordance with the present disclosure. It should also be noted that the components of network based processing system 210 and the data sharing platform 205 may comprise various combinations of computing resources (e.g., processor(s), memory unit(s), and/or storage unit(s)) on the same or different host devices, at the same or different locations (e.g., in the same or different data centers). For example, processors assigned to execute instruction sets for different components may be separate from the associated memory resources, which may be separate from associated storage resources where data sets or other data which may be processed via the different components may be stored, and so on. In one embodiment, the network based processing system 210 operates as a service broker 210.

As further illustrated in FIG. 2, the context data sharing platform 205 includes a plurality of sandboxes 226-229 (e.g., “private sandboxes’) and a public access application programming interface (API) gateway 240. In various examples, sandboxes 226-229 (broadly storage locations), the context data sets 281-284 stored in the different sandboxes 226-229, and/or the public access API gateway 240, may comprise virtual machines, application containers, or the like operating on one or more host devices. In addition, sandboxes 226-229, the context data sets 281-284 stored in the different sandboxes 226-229, and/or the public access API gateway 240 may comprise various combinations of computing resources, e.g., processor(s), memory unit(s), and/or storage unit(s) on one or more shared host devices and/or on separate host devices. Each of the context data sets 281-284 may take a variety of different forms, e.g., table-based records, video, audio, documents in various formats, and so forth. However, for non-table based data sets, metadata regarding the various data/records may be maintained in table form. In one example, the context data sharing platform 205 may comprise a relational database system (RDBS). However, in other, further, and different examples, context data sharing platform 205 may comprise a different type of database system, such as a hierarchical database system, a graph-based database system, etc.

The context data sharing platform 205 may provide services to a number of different users, and interact with a number of user devices, such as context data owner devices 231-233 and context data consumer devices 235. Each of the user devices may comprise a desktop computer, a cellular smart phone, a laptop, a tablet computer, a cloud based processing system providing a user environment, a server, and so forth. In particular, context data sharing platform 205 may be operated by a trusted party to store context data sets on behalf of context data owners in a secure and restricted manner, and to provide context data consumers with context data sharing community-based access to multiple context data sets in accordance with authorizations/permissions from context data owners for traveling events of one or more users.

To illustrate, sandbox 226 may store context data set 281 for a first context data owner, which may comprise medical information for various individuals. The context data set 281 may include raw data (e.g., biometric sensor data) and/or may include context data that is normalized, transformed, tagged, etc. (e.g., health summary records) before uploading to the context data sharing platform 205. In one example, the context data in data set 281 may be uploaded via context data owner device 231 and stored in sandbox 226. Alternatively, or in addition, the context data sharing platform 205 may be configured to obtain and/or receive the context data comprising context data set 281 directly from biometric sensors of various individuals (not shown). The sandbox 226 may represent a secure data storage and data processing environment that is only accessible to the first context data owner (or another person or entity authorized on behalf of the first context data owner) and to the context data sharing platform 205. Having access to a user's medical information and/or current biometric data will assist the service broker 210 in providing the most relevant recommendations and/or take the most appropriate actions on behalf of the user. For example, knowing the user may potentially be prediabetic may impact the restaurant recommendations presented to the user, e.g., recommending restaurants that advertised as having menu items appropriate for prediabetic individuals, and so on. Similarly, knowing the user may potentially be anxious via the current biometric data may impact the activity recommendations presented to the user, e.g., recommending a soothing massage session instead of recommending a visit to a nearby amusement park, and so on.

Similarly, sandbox 227 may store context data set 282 for a second context data owner, which may comprise a vehicular on-board processing system management service. The vehicle may be the user's own vehicle, a rental vehicle or a rideshare vehicle with the capability to provide context data, e.g., current location data, current speed data, current acceleration data, current user “hands-free” data (e.g., whether the user is driving the vehicle or is simply a passenger in the vehicle) and so on. The context data set 282 may include raw data and/or may include context data that is normalized, transformed, tagged, etc. before uploading to the context data sharing platform 205. In one example, the context data in data set 282 may be uploaded via context data owner device 232 and stored in sandbox 227. Alternatively, or in addition, the context data sharing platform 205 may be configured to obtain and/or receive the context data comprising context data set 282 directly from various vehicular on-board processing systems (not shown). For instance, the context data may include dashcam videos, engine diagnostics, entertainment system usage information, fuel status, braking information, tire pressure information, and so forth. The sandbox 227 may represent a secure data storage and data processing environment that is only accessible to the second context data owner (or another person or entity authorized on behalf of the second context data owner) and to the context data sharing platform 205. Having access to a user's vehicular data will assist the service broker 210 in providing the most relevant recommendations and/or take the most appropriate actions on behalf of the user. For example, knowing the user is currently a passenger instead of a driver may impact the activity recommendations presented to the user, e.g., recommending a viewing of a particular multimedia program if the user is currently a passenger, whereas an audio only media may be presented if the vehicular data indicates that the user is currently driving the vehicle, and so on.

In addition, sandbox 228 may store context data set 283 for a third context data owner, e.g., a traffic management service, which may comprise toll payment data, records of traffic volume estimates, traffic signal timing information, and so forth. The context data set 283 may include raw data and/or may include context data that is normalized, transformed, tagged, etc. before uploading to the context data sharing platform 205. In one example, the context data in context data set 283 may be uploaded via context data owner device 233 and stored in sandbox 228. Alternatively, or in addition, the context data sharing platform 205 may be configured to obtain and/or receive the context data comprising context data set 283 directly from a traffic management system (not shown). The sandbox 228 may represent a secure data storage and data processing environment that is only accessible to the third context data owner (or another person or entity authorized on behalf of the third context data owner) and to the context data sharing platform 205. Having access to traffic data relative to a user will assist the service broker 210 in providing the most relevant recommendations and/or take the most appropriate actions on behalf of the user. For example, knowing the user is currently at a particular toll plaza may impact the activity recommendations presented to the user, e.g., recommending a rescheduling of a dinner reservation given that the user will likely miss the dinner reservation given the current location of the toll plaza in relation to the location of the restaurant, or sending a text message on behalf of the user to another member of the dinner party indicating that the user will likely be late (with or without the current estimated time of arrival of the user) based on the current location of the toll plaza in relation to the location of the restaurant, and so on.

In one example, context data owners may make portions of the context data sets 281-283 available to other users of the context data sharing platform 205. For instance, network-based processing system 210 may run one or more event detection filters for detecting trigger conditions for one or more events. In one embodiment, the detected trigger condition pertains to a traveling event for a user, e.g., location information, e.g., GPS information, and speed information associated with a user can be used to indicate that the user is currently traveling in a vehicle and so on. The trigger conditions may be detected via context data of any one or more of the context data sets 281-283. In one example, owners of context data sets 281-283 may grant permission for the network-based processing system 210 to scan all or a portion of the context data of the context data sets 281-283 for such purposes. In one example, when a trigger condition is detected, network-based processing system 210 may dynamically create another sandbox 229 and populate the sandbox 229 with the relevant context data 284 for use by a new context data sharing community for a newly detected traveling event associated with a user. Namely, a new context data sharing community can be created for each trip that is taken by a user, e.g., context information can be shared by various service agents in a first context data sharing community when the user is going to work, whereas a second context data sharing community is subsequently established when the user is going back home, where each context data sharing community may be provided with its unique set of context data. This dynamic establishment/teardown of context data sharing communities allows the user to tightly control how context information will be collected, stored, and used. Namely, the user is given the option to allow the collected context data to be used for one or more trips as the user deem appropriate.

In addition, network-based processing system 210 may gather context data from any one or more of the context data sets 281-283 and copy the context data to the context data set 284 in sandbox 229. For example, the network-based processing system 210 may access context data sets 281-283 to obtain the relevant data, to filter, join, select columns, generate projections, and/or perform other operations in accordance with the event type template. In one example, the network-based processing system 210 is granted read-only access to the context data sets 281-283.

It should be noted that context data in the context data sets 281-283 may have time-based rules for data expiration, data aggregation or summarization, or the like. However, in one example, the occurrence of an event, and hence the establishment of a context data sharing community, may cause various context data of the context data sets 281-283 to be maintained in a particular format and/or retained in the context data sharing platform 205 for longer than would otherwise be the case. In one example, the network-based processing system 210 may also begin to gather new context data from external data sources when a context data sharing community is established. For instance, context data owner device 233 may not typically upload context data to the context data sharing platform 205. However, the owner of context data owner device 233 may have agreed to contribute context data in connection with a particular context data sharing community (e.g., when the trigger condition for establishing the context data sharing community is encountered such as a particular type of traveling event such as an international traveling event). Thus, in one example, the network-based processing system 210 may create sandbox 228 and begin populating context data set 283 with context data from context data owner device 233. This may be performed as an alternative or in addition to logging context data into context data set 284 of sandbox 229 that is created exclusively for the context data sharing community when the context data sharing community is initially established. In one example, the network-based processing system 210 may further apply transformations to the context data in accordance with the event type template, e.g., identifying individuals, license plates, etc. in a photograph or video and blurring out or blocking faces, license plates, etc., anonymizing fields in a database, excluding certain rows or columns of data, extracting records for certain time periods and omitting the remainder, and so forth.

In one example, network-based processing system 210 may also provide via the public access API gateway 240 one or more tickets (e.g., a Kerberos ticket, an X.509 certificate, or the like), to allow context data consumer devices 235 to access the sandbox 229 and/or context data set 284 to retrieve the relevant context data associated with the traveling event. In one example, network-based processing system 210 may also push context data from context data set 284 (e.g., context data collected from context data sets 281-283 and/or from external context data source devices of the context data sharing community in accordance with the event type template) to context data consumer devices 235 in accordance with the event type template. Alternatively, or in addition, context data consumers, via context data consumer devices 235 may subscribe to certain aspects of context data set 284 when initially using a ticket to access the context data sharing community (e.g., to access sandbox 229 and/or context data set 284). For example, a first context data consumer may want to receive any video feeds of the users that are available in real time while a second context data consumer may want to receive biometric data of the users in real time.

It should also be noted that one or more of the context data consumer devices 235 may comprise an automated service agent, such as a device running an application (e.g., a MLA) for detecting certain conditions, for providing alerts, notifications, or control signals in response to such detected conditions, and so forth. For example, one of context data consumer devices 235 may be able to detect vehicle license plates in images or videos, to perform image pattern matching to determine the license plates'states, to perform optical character recognition on detected license plates to determine the license plate numbers, and so forth. Various additional context data consumer devices 235 may comprise automated service agents of a same or a similar nature. In addition, in one example, one or more of the context consumer devices 235 may also be enrolled as a context data source device. For example, one of the context consumer devices 235 for determining states and plate number of license plates may also provide the results back to the context data sharing community as additional context data to be aggregated in context data set 284. Similarly, one or more of the context data owner devices 231-233 may also be enrolled as both a context data source device and a context data consumer. For instance, an on-board processing system of a vehicle may contribute video data from a dashcam, and may also receive access to detected license plate information, medical information, and so forth as a context data consumer, either by permitted access upon request, e.g., using an access token, and/or or via proactive push transfer of new context data.

In one embodiment, the network based processing system is implemented as a service broker 210 comprising a decision analyzer 212, a profile collector 214, and an action delivery system 216. As discussed above, the decision analyzer uses machine learning to determine the current context for a user who is interacting with a particular service agent, and will determine a set of actions or recommendations that can be taken or presented by that particular service agent based on that context. In one example, the MLA may comprise at least one of: a deep neural network (DNN), a generative adversarial network (GAN), or the like. In one example, the machine learning algorithm may further include an exponential smoothing algorithm, (e.g., Holt-Winters triple exponential smoothing) and/or a reinforcement learning algorithm. It should be noted that various other types of MLAs and/or MLMs may be implemented in examples of the present disclosure, such as k-means clustering and/or k-nearest neighbor (KNN) predictive models, support vector machine (SVM)-based classifiers, e.g., a binary classifier and/or a linear binary classifier, a multi-class classifier, a kernel-based SVM, etc., a distance-based classifier, e.g., a Euclidean distance-based classifier, or the like, and so on.

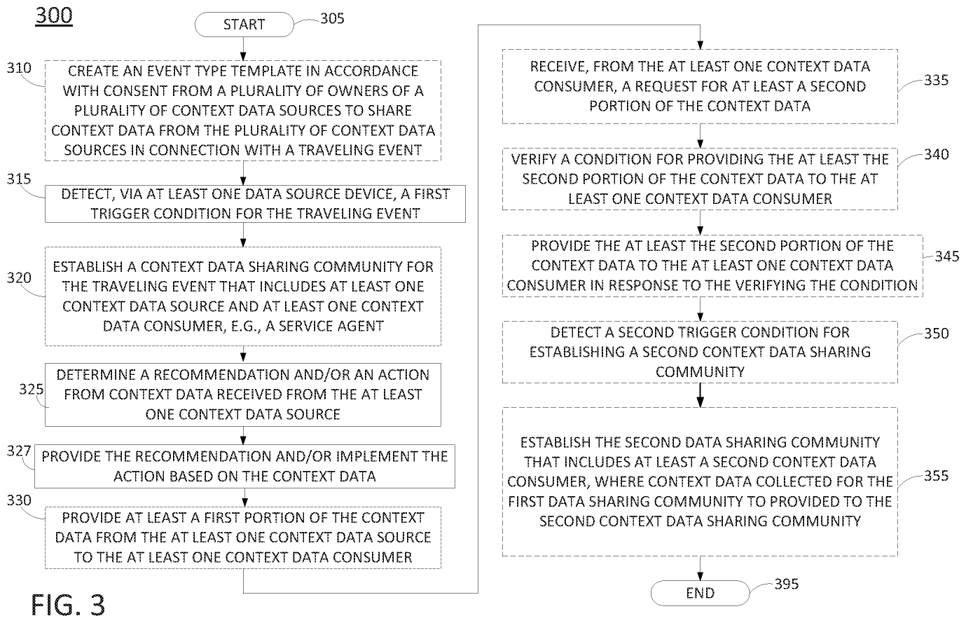

The service broker 210 once trained with the MLA, will interact with the profile collector 214 and action delivery system 216 to provide a connected context based experience to a user during a traveling event. As discussed above, the profile collector 214 may receive, organize and/or store contextual data that are received from one or more service agents. The decision analyzer 212 will utilize the collected contextual data to deduce a recommendation and/or an action to be performed for a user, where the action delivery system 216 is then tasked with executing any actions presented by the decision analyzer 212. The operations of the service broker will be discussed in view of FIG. 3 below.

Finally, it should also be noted that the example of FIG. 2 is provided only as an illustrative example. In other words, in other, further, and different examples, the context data sharing platform 205 may comprise a different architecture. For instance, operations that are described as being performing in connection with one component may alternatively or additional be performed by a different component. In addition, while the context data sets 281-284 are illustrated as residing within sandboxes 226-229, it should be noted that the actual storage of context data sets 281-284 may be distributed in a plurality of different storage devices which may reside within a plurality of different physical locations, where the sandboxes 226-228 comprise environments where the respective context data sets 281-283 can be fully or partially accessed. For example, sandboxes 226-228 may each represent at least a portion of a respective user application provided to context data owner devices 231-233 via the context data sharing platform 205. For instance, the user applications may run on network-based processors and memory units of context data sharing platform 205, where the sandboxes 226-228 may possess security tokens (e.g., decryption keys) for rendering context data sets 281-283, respectively. Thus, the storage locations of the context data sets 281-283 may be arbitrary, and the context data owner devices 231-233 and context data consumer devices 235 may interact with the context data sets 281-284, perform data analysis, visualizations, and so forth via the respective user applications hosted by the hardware of context data sharing platform 205. In one example, context data sets 281-284 may be part of a set of file stores such as a Hadoop Distributed File System (HDFS) and/or another cloud file storage system. Thus, these and other variations, modifications, and/or enhancements, are all contemplated within the scope of the present disclosure.

FIG. 3 illustrates a flowchart of an example method for providing a connected context based experience to a user during a traveling event, in accordance with the present disclosure. In one example, steps, functions and/or operations of the method 300 may be performed by a device as illustrated in FIG. 1, e.g., one or more of servers 112, or by a network-based processing system 210 as illustrated in FIG. 2. Alternatively, or in addition, the steps, functions and/or operations of the method 300 may be performed by a processing system collectively comprising a plurality of devices as illustrated in FIG. 1 such as one or more of servers 112, DB(s) 136, context data source devices 120, service agents 180-183, sensor 154, and so forth, or as illustrated in FIG. 2, such as network based processing system 210, context data sharing platform 205, context data owner devices 231-233, context data consumer devices 235, and so forth. In one example, the steps, functions, or operations of method 300 may be performed by a computing device or system 500, and/or a processing system 502 as described in connection with FIG. 5 below. For instance, the computing device 500 may represent at least a portion of a platform, a server, a system, a device and so forth, in accordance with the present disclosure. For illustrative purposes, the method 300 is described in greater detail below in connection with an example performed by a processing system. The method 300 begins in step 305 and may proceed to optional step 310 or directly to step 315.

At optional step 310, the processing system may create a template for an event type in accordance with consent from a plurality of owners of a plurality of context data sources to share context data from the plurality of context data sources in connection with a traveling event. The consent may establish the event type template, which may include at least one trigger condition for the traveling event, a duration of time associated with a detection of the at least one trigger condition for which the context data from the plurality of context data sources is shareable, data fields of the context data which are shareable in connection with the traveling event, and permission levels for a plurality of context data consumers in connection with the traveling event. The consent may further establish the event type template to include at least one of: at least one retention time period for retaining the context data from the plurality of context data sources or an expiration condition for the context data sharing community. The expiration condition may comprise a particular time, a duration of time since the creation, or may comprise a signal from one or more of the context data consumers (e.g., an authorized context data consumer) to end the context data sharing community. For example, the user or a third party service providing entity (e.g., a medical institution, a hotel operator, a rideshare entity and the like), may be authorized to signal the end of the context data sharing community.

At step 315, the processing system detects, via at least one context data source device, a trigger condition for a start of a traveling event. In one example, the trigger condition may be based upon sensor data (e.g., on/off, measurement value exceeded, etc.) or may be in accordance with one or more automated agents, e.g., a machine learning algorithm (MLA) to detect a movement of a mobile device (e.g., a smart phone, a mobile tablet computer, etc.) associated with the user relative to a known location (e.g., a home, a work office, an airport, a bus station, a train station, a tunnel, a bridge, a building, a toll plaza, and so on), the presence of a vehicle associated with the user relative to a known location, the presence of a user, etc. from an image or video feed, to detect an ID badge (e.g., an RF tag) associated with the user, e.g., from sensor data from a plurality of sensors and/or from an image, sound, and/or video feed, and so forth. In one example, the user may simply inform the network based processing system 210 that the user is now beginning a traveling event via user input, e.g., via the service agent 180 on the user's mobile endpoint device 131. In one example, the trigger condition may be in accordance with an event type template (e.g., an event type template that may be created at optional step 310) that dictates how to interpret the beginning of a traveling event for each registered user.

At optional step 320, the processing system establishes a context data sharing community for the event. The context data sharing community may comprise a plurality of context data sources, e.g., including the at least one context data source device via which the trigger condition is detected, and a plurality of context data consumers (e.g., service agents). In one example, step 320 includes setting permission levels for the plurality of context data consumers. In one example, the context data sharing community is established in accordance with an event type template (e.g., an event type template that may be created at optional step 310). The plurality of context data sources may include, for example: at least one video source device, at least one audio source device, at least one image source device, at least one biometric sensor device, or at least one sensor device. The plurality of context data sources may alternatively or additionally include: at least one data set comprising heath information of at least one user, at least one data set comprising demographic information of at least one user, or at least one data set comprising personal information of at least one user. In one example, the processing system may store context data belonging to individual context data owners/users. The processing system may also store personal information of a third-party context data owner on behalf of individual users, e.g., a fitness tracking service provider, a telecommunications service provider, a health care service provider, a company that employs the user, and so on.

In one example, the establishing of the context data sharing community may comprise identifying at least one location of at least one of the plurality of context data sources, and including at least one of the plurality of context data sources in the context data sharing community when the at least one location is within a threshold distance from a location of the traveling event. For example, the presence of a user may be detected via a camera or an RF receiver directed at a roadway. Then, additional service agents (e.g., other cameras or RF receivers) proximate the roadway may be dynamically enrolled as context data source devices in the context data sharing community. However, available cameras that might be included in other context data sharing communities may be omitted from selection when deemed too far away from the current traveling event to be relevant. In one example, the threshold distance-based criteria for including a context data source in the context data sharing community applies to context data source devices with active feeds, such as video cameras, biometric sensor devices, etc., but does not relate to context data sources with relatively static information, such as an insurance database, a driver database, demographic information of users maintained by a telecommunication network service provider, etc. Alternatively, members of the context data sharing community can be predefined by the user, e.g., where the user dictates which type of service agents may share context data of the user while the user is traveling.

At step 325, the processing system determines one or more recommendations and/or actions to be taken from context data collected from the plurality of context data sources in accordance with the traveling event (e.g., based upon a template for the event type that may be created at optional step 310). In one example, step 325 may include gathering context data from the context data source device via which the traveling event is detected, and gathering context data from one or more additional context data sources. In one example, step 325 may comprise retaining context data from the plurality of context data sources for a duration of time in excess of a default retention period. For example, if the processing system typically retains only 48 hours of video in accordance with the configuration of the context data owner, the processing system may instead keep selected portions of the context data for longer if deemed relevant to the traveling event (e.g., in accordance with the event type template and per the consent of the context data owner). For example, context data can be kept for a longer period of time for a traveling event relating to a user on an international trip than compared to a traveling event relating to a user simply going to and from work. Namely, it is likely that the user will benefit from the automated assistance provided by the present system when the user is traveling abroad which may need access to the context data for a longer period of time.

Alternatively, or in addition, step 325 may involve storing context data that would not otherwise be stored. For example, a video camera may not typically provide streaming video for storage by the processing system. However, according to the consent of the owner of the video camera, the video camera may be enrolled as a context data source device for a traveling event. Thus, there may be no data sharing in general for the particular video camera, but this may be altered for unique scenarios, e.g., when there is a traffic accident or a natural disaster, e.g., a wildfire, an earthquake, a snow storm or a hurricane, while remaining in accordance with context data owner restrictions (e.g., to only retain the data until the traveling event is ended for the user, to anonym ize portions of the video, etc.). In one example, the processing system is granted consent to store context data sets on behalf of a plurality of owners of the plurality of context data sources and to access the context data sets in accordance with the traveling event. In one example, the context data from the plurality of context data sources is stored by the processing system in separate context data sets for each of the plurality of owners of the plurality of context data sources, where each of the separate context data sets is accessible to a respective one of the plurality of owners and is inaccessible to others of the plurality of owners.

In one example, step 325 may comprise anonymizing at least a first portion of the context data from the plurality of context data sources. For instance, when the at least the first portion of the context data comprises images or a video, the anonymizing may comprise obfuscating at least a portion of the images or the video, such as blurring or blocking out vehicles, license plates, people who are not related to the traveling event of the user, children, etc. In one example, the anonymizing may include obfuscating context data (e.g., randomizing within a range), or deleting or omitting certain fields, rows, columns, entries, etc. For instance, the at least the first portion of the context data may comprise personally identifiable information (e.g., a name, an email, a social security number, a driver's license number, a birthdate, etc.), demographic information (such as gender, height, weight, race, age, education, income, assets, etc.), or biometric information (such as heart rate, temperature, blood pressure, skin conductance, etc.).

In step 325, the processing system will analyze the received context data to determine one or more recommendations and/or actions to be taken on behalf of the user. In one embodiment, the processing system utilizes machine learning to deduce the one or more recommendations and/or actions to be taken on behalf of the user.

At step 327, the processing system provides the one or more recommendations and/or implements the more or more actions based on the context data. Namely, the processing system may interact with one or more service agents to present one or more recommendations to the user based on an analysis of the context data. In addition or in the alternative, the processing system may implement one or more actions for the user based on an analysis of the context data. For example, the user may respond to one of the presented recommendations and the processing system may then implement an action corresponding to the user's response or selection. However, the implementation of the action does not necessarily require presenting a recommendation first to the user. For example, there may be scenarios where the user has previously authorized or the processing system has previously learned that the user would approve of an action taken automatically on behalf of the user, e.g., automatically sending a text message to the user's spouse that the user's flight has arrived at a destination airport that the user is currently traveling to.

At optional step 330, the processing system provides at least a first portion of the context data from the plurality of context data sources to at least a first context data consumer of the plurality of context data consumers in accordance with a permission level of the at least the first context data consumer. In one example, the processing system may provide the at least the first portion of the context data upon receiving a request from the first context data consumer. Alternatively, or in addition, the processing system may provide the at least the first portion of the context data to the first context data consumer according to a push notification model. In one example, at least one of the context data sources may also be one of the context data consumers, e.g., an in-vehicle computing system may provide dashcam video footage, and the in-vehicle computing system may also receive context data from the processing system as a context data consumer, e.g., to aid in navigating during the traveling event or to provide a service to the user, e.g., providing a multimedia stream to the user while the user is traveling in the vehicle. For example, the service broker 210 may provide context data (e.g., the user is currently traveling to see a movie) to various service agents 180-183 (e.g., a service agent in a vehicle to provide movie previews in the vehicle, a service agent of a restaurant where the user has a reservation after the movie to prepare a dessert after the movie where the dessert has to be made in advance, and so on).

At optional step 335, the processing system may receive, from the at least the first context data consumer, a request for at least a second portion or level of the context data of the plurality of context data sources. For example, the second portion of the data may comprise context data that is not shareable in accordance with the permission level of the at least the first context data consumer at the time of the providing of the at least the first portion of the context data. For instance, there may be scenarios where the user only authorized a service agent to receive a limited set of context data, but would be receptive to the service agent to receive additional context data at a later time. For example, the user may be traveling with a companion who the user may offer a proposal of marriage during the trip. The user may initially authorize the context data of “personal travel” to be released and shared among the service agents that will be encountered during the trip. However, once the proposal has been made by the user, the user may then authorize the context data of “personal travel for marriage proposal” to be released and shared among the service agents that will be encountered during the trip. This updated context data allows the service agents to update its previous recommendations/actions or to provide new recommendations/actions. For example, a hotel service agent may automatically update the user's room to a suite or a bottle of champagne is sent to the user's current room or the airline service agent may automatically upgrade the seating of the user and the user's companion based on the additional context data and so on.

At optional step 340, the processing system may verify a condition for providing the at least the second portion or level of the context data to the at least the first data consumer. For example, the condition may comprise a distance of at least the first context data consumer relative to a current location of the traveling event. To illustrate, an event type template for the traveling event may indicate that a first level of context information pertaining to the general purpose of the traveling event (e.g., traveling for pleasure) may be provided to all service agents within a given geographical range. However, the user may actually be visiting a vacation area where the user is contemplating relocating in the future for the purpose of taking a new job. The location of the potential new job may be located at a particular county, e.g., XYZ county. The user may then only authorize the context data pertaining to “evaluating the surrounding areas pertaining to company ABC situated in the XYZ county,” to be accessible only by a service agent related to a real estate relocation company. In other words, the user may have multiple “layers” of purpose (context) for taking a particular trip, where the user may set different levels of access corresponding to different levels of context data. Using the above example, the real estate relocation service agent may be given access to all levels of context data for the user so that the real estate relocation service agent will be able to present the most relevant recommendations (e.g., recommending nearby family attractions, recommending nearby restaurants, recommending nearby attractions rated highly by singles or young adults who recently moved to the area, and so on) and/or to take the most relevant actions (e.g., providing a listing of available homes for sale, providing a listing of available homes and/or apartments for rent, providing a report of the ratings of the various school districts, providing crime report statistics pertaining to the various nearby towns, arranging real estate showings of available homes/apartments, and so on). Limiting access by the various different service agents by the user will equip the user with a high degree of control as to the use and proliferation of the user's context data.

In another example, the condition may comprise receiving an affirmation from the at least the first context data consumer of an emergency situation. For example, consent from context data owners may provide for limited sharing for a particular situation during the traveling event. However, when an emergency condition exists, the context data owners may allow more open sharing of the context data, but only when an affirmation (which is recordable and reproducible) is provided by a context data consumer that is authorized to make such an affirmation (and to request and to receive the at least the second portion of the context data). For instance, EMT, police, and fire personnel may gain access to traveling plans and itineraries, blood type information, biometric information, and other health information in an emergency situation for users, but this information may not similarly be released to an insurance company, a restaurant, an entertainment service provider, a hotel, etc. via the processing system. Likewise, an insurance company may not be authorized to declare an emergency and may not receive this information even when one of the other context data consumers does declare an emergency. Namely, the user may predefine which and what entities are allowed to declare the emergency situation for the purpose of gaining a higher level of context data pertaining to the user while the user is currently on the traveling event.

At optional step 345, the processing system may provide the at least the second portion or level of the context data to the at least the first context data consumer in response to verifying the condition. In one example, the processing system may establish a push notification model to provide a feed comprising the at least second portion or level of the data to the at least the first context data consumer. For instance, at least the first context data consumer may be provided, at a device of the at least the first context data consumer, a video feed, a biometric data feed, etc. in real-time (e.g., at the speed at which the processing system is capable of obtaining the at least the second portion or level of the context data and providing the at least the second portion or level of the context data to the device, accounting for normal processing delays, network delay, etc.).

At optional step 350, the processing system may detect a second trigger condition for establishing a second context data sharing community for the traveling event. In one example, detecting the end of the traveling event can be used as the basis of terminating the context data sharing community established in step 320. Such termination may also be a trigger to start a new context data sharing community. For example, the second trigger condition may comprise receiving declarations from one or more of the context data consumers that the traveling event has ended for the user, e.g., via a message to the processing system via a user interface of a device of the one or more of the context data consumers. In another example, the second trigger condition may comprise automatically detecting that a traveling event has ended for the user, e.g., detecting the user's vehicle arriving at home, detecting the user's smart phone inside of the user's home, detecting the user's smart phone inside of the user's office at work, etc. In yet another example, the second trigger condition may comprise automatically detecting that a new traveling event has started for the user, e.g., detecting the user's vehicle leaving home, detecting the user's smart phone at the parking lot, detecting the user's smart phone outside of the user's office, etc.

Alternatively, at optional step 350, the processor may detect a second trigger for establishing a second context data sharing community for the traveling event without terminating the earlier established (first) context data sharing community. As discussed above, the purpose of a traveling event may have multiple layers or levels of purpose. If the user has two layers or tiers of purpose for the traveling event, then in step 355 a second context data sharing community can be established based on the second trigger condition. As discussed above, in one example the main purpose of a user traveling to an area may be for vacation, but a secondary purpose may be to evaluate the area for a possible future relocation due to a potential job change. As such, the context data of “vacation travel” may be presented to a number of service agents of a first context data sharing community that are connected to present a robust vacationing experience. However, these service agents of the first context data sharing community may not be privy to the additional context data of “potential job relocation at the trip location.” A second set of service agents (e.g., a service agent for a real estate company, a service agent for a job search agency, and the like) of the second context data sharing community may have access to this additional context information. The second trigger condition may comprise receiving an input from the user to setup the second context data sharing community where service agents of the first context data sharing community are to be excluded and/or where the additional context data is not provided to the service agents of the first context data sharing community, and so on.

At optional step 355, the processing system may establish the second context data sharing community, where the second context data sharing community may include at least a second context data consumer. In one example, the processing system may collect and/or store aggregate context data derived from the at least a first portion of the context data from the plurality of context data sources. Thus, the aggregate context data may be accessible to the at least the second context data consumer via the second context data sharing community. In one example, the data can be anonymized to be shared for additional public study, such as statistics regarding what happened, demographics of involved parties, etc. For example, the processing system may create the second context data sharing community to publish the aggregate context data for study by one or more researchers. However, it should be noted that in one example, the establishment of the second context data sharing community does not necessarily limit the publication of anonymized aggregate context data to a public data set. In one embodiment, anonymized aggregate context data means that personal information of each user will be deleted from the context data. For example, context data relating to Jane Doe and John Doe who are parents of two children while traveling on vacation to ABC location ate at a recommended Italian restaurant and spent $100 on a meal can be very useful information for training the service broker 210. Such service broker 210 with the usage of machine learning will allow the service broker 210 to gain a high level of insights and accuracy in providing the most relevant recommendations and/or take the most relevant actions on behalf of a multitude of users. However, the personal information of Jane Doe and John Doe must be protected. Thus, the processing system will anonym ize the personal information (e.g., names, home address, age, gender, income level and so on) of Jane Doe and John Doe so that the processing system will be trained with information that has been anonymized so that all personal information are omitted or deleted. Thus, in this example the input context information may be reduced to a family of four enjoyed a meal at a recommended Italian restaurant and spent an average of $100 on the meal while on vacation at destination XYZ. In other words, the user's context information will be protected and the processing system can be improved over time in providing a connected context based experience to one or more users during a traveling event.

Finally in one example, unlike the first context data sharing community, the second context data sharing community may be able to access both the context data accessible by the first context data sharing community and the additional context data that is solely provided to the second context data sharing community. This architecture allows the user to specify different levels of context data to be used for different purposes, thereby allowing a high degree of control as to how the user's context information will be used.

Following step 330, or any one of optional steps 330-355, the method 300 may proceed to step 395. At step 395, the method 300 ends.

It should be noted that the method 300 may be expanded to include additional steps or may be modified to include additional operations with respect to the steps outlined above. For example, the method 300 may be expanded to include repeating steps 325 and 330 through multiple iterations. In another example, the method 300 may be expanded to include receiving a request for additional data of one or more context data sources, submitting the request to one or more of the context data owners, receiving authorizations to release the context data, and providing the context data to the requesting context data consumer in accordance with the permission. In still another example, the method 300 may be expanded to include ending the first context data sharing community upon one or more conditions. It should be noted that when the first context data sharing community ends, context data retained in connection therewith may be deleted, or the context data may be protected for a brief time period and then declassified per users' authorization only. Thus, these and other modifications are all contemplated within the scope of the present disclosure.

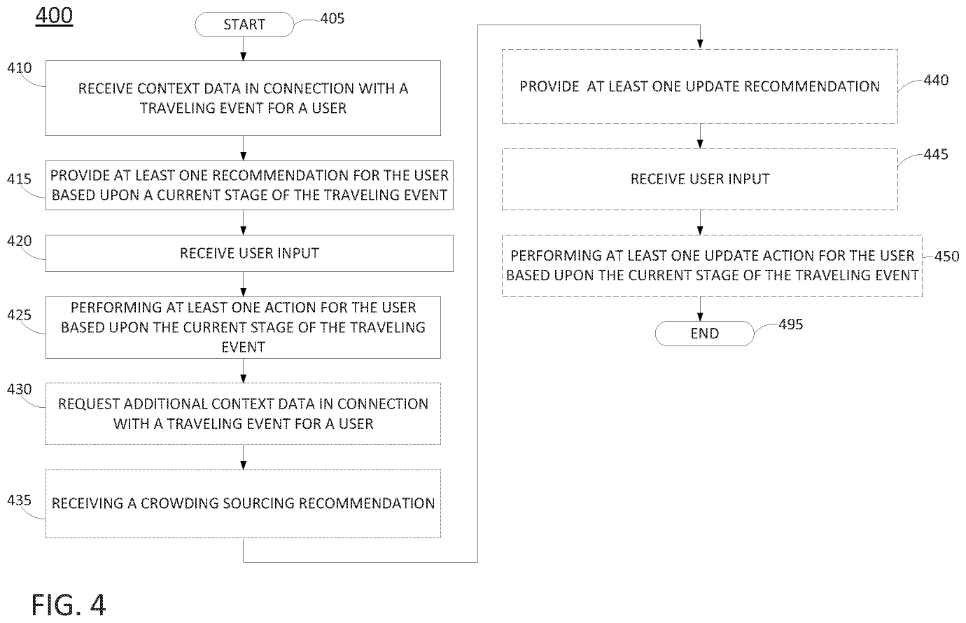

FIG. 4 illustrates a flowchart of an example method 400 of a service agent for assisting in providing a connected context based experience to a user during a traveling event, in accordance with the present disclosure. In one example, steps, functions and/or operations of the method 400 may be performed by a device as illustrated in FIG. 1, e.g., one or more of computing devices employing one or more service agents 180-183. In one example, the steps, functions, or operations of method 400 may be performed by a computing device or processing system 500, and/or processor 502 as described in connection with FIG. 5 below. For instance, the computing device 500 may represent at least a portion of a platform, a server, a system, a device and so forth, in accordance with the present disclosure. For illustrative purposes, the method 400 is described in greater detail below in connection with an example performed by a processing system. The method 400 begins in step 405 and may proceed to step 410.

At step 410, the processor may receive context data in connection with a traveling event for a user. For example, a service agent such as a service agent for a hotel operator, may receive context data (e.g., from service broker 210) pertaining to the user, e.g., a guest staying at the hotel. To illustrate, the context data may comprise the purpose or reason for staying at the hotel, e.g., the purpose may be a college tour to visit a number of universities near the hotel. This example of context data is only an illustrative example.

At step 410, the processor may provide at least one recommendation to the user, e.g., based on the current stage of the traveling event, e.g., the user is checking into the hotel, the user is in the middle of a week-long stay, the user is checking out of the hotel, and so on. The at least one recommendation may pertain: to visit a local historic site, to eat at a particular restaurant, to try a type of local famous food item, to attend a show, to attend a festival, to visit a particular university, to visit a particular neighborhood when student dormitories of the university reside, and so on. Thus, the types of recommendations are based on the context data received by the service agent for the user.

At step 420, the processor may receive input from the user directly. For example, the user may wish to engage in one of the activities provided in the at least one recommendation. This will allow the service agent to take an action on behalf of the user, e.g., scheduling an event, buying a ticket, making a reservation, ordering an item or a service, and so on. In another example, the user may provide further contextual information, e.g., indicating to the service agent that the user is visiting the area for the purpose of a college tour and is particularly interested in visiting various amenities of the university, e.g., student housing facilities, sports facilities, educational classroom facilities, dining facilities, and so on. The ability to receive direct input from the user pertaining to context data will enhance the accuracy and performance of the service agent. In another example, the user may present questions to the service agent as to the recommendations presented to the user in step 415. For example, the user may inquire as to the cost, time duration, location, transportation needs, time constraints associated with the recommendations which will allow the service agents an opportunity to further refine the presented recommendations.

At step 425, the processor may perform at least one action for the user, e.g., based on the current stage of the traveling event, e.g., the user is checking into the hotel at a very late time of the day. The service agent may present some recommendations as to various restaurants that are still open for providing food delivery service to the hotel. In response to direct user input received in step 420 and/or in response to received context data relating to the user (e.g., an airline service agent may have indicated to the service agent at the hotel that no food was offered on the flight taken by the user prior to arrival at the hotel, and an airport service agent indicated that all restaurants at the airport were closed when the user's flight landed, and the rideshare service agent indicated that the user traveled directly from the airport to the hotel, and so on), the service agent at the hotel may implement the action of ordering a food item to be delivered to the hotel for the user.

At optional step 430, the processor may request additional context data in connection with the traveling event for the user. For example, the service agent at the hotel may attempt to obtain an itinerary for a college tour to be taken by the user on a following day. Such additional context data may assist the service agent at the hotel to make additional recommendations and/or take additional actions for the user.

At optional step 435, the processor may receive a crowd sourcing recommendation (e.g., from service broker 210 via one of the context owner device). For example, the service agent at the hotel may anonym ize the user's context data and present the anonymized user's context data to a crowd sourcing site or crowd sourcing application for soliciting additional recommendations. For example, the service agent at the hotel may pose the following question: What should an individual do if the individual is visiting ABC university tomorrow?; What unique events should an individual attend if the individual is visiting ABC university tomorrow?; What locations of the ABC university should an individual visit if the individual is visiting ABC university tomorrow?; and so on. By allowing the service agent (or alternatively the service broker 210) the capability of assessing additional recommendations presented by the crowd sourcing site or crowd sourcing application will allow the service agent to provide a more robust experience to the user. For example, a student organization at the ABC University may be sponsoring an outdoor event tomorrow at the ABC University that will showcase certain senior projects of various students and the like. In another example, the user may be scheduled to attend a sports event, e.g., a baseball game during his stay at the hotel. The additional recommendation may be from an individual who attended a similar sports event recently and recommends that the user visit the gift shop at the baseball stadium for deeply discounted items. Such events may not be within the knowledge base of the service agent or service broker. In turn, the service agent may then independently verify the veracity, feedback and/or ratings associated with the additional recommendations presented by the crowd sourcing site or crowd sourcing application.

If the additional recommendation is indeed presented to the user and the user accepts the additional recommendation and then subsequently provides positive feedback to the service agent or service broker, then a reward (e.g., a small monetary reward, a “like” rating reward, a point reward in a point based system for providing a good recommendation, and so on) can be issued to the individual of the crowd sourcing site or crowd sourcing application who provided the additional recommendation. This reward method will encourage accurate and relevant crowd sourcing recommendations that will enhance the overall ability of the service agent or service broker in providing its connected service to the user.

At optional step 440, the processor may provide at least one update recommendation to the user, e.g., based on the additional recommendation received from the crowd sourcing site or crowd sourcing application. This allows the service agent to be able to dynamically provide the most up to date recommendations to the user.

At optional step 445, the processor may again receive input from the user directly. For example, the user may wish to engage in one of the activities provided in the at least one update recommendation.

At optional step 450, the processor may perform at least one update action for the user, e.g., based on the current stage of the traveling event. For example, the user may wish to engage in one of the activities provided in the at least one update recommendation. If so, the service agent will take an action to effect the selected activity for the user, e.g., making a reservation, ordering a ticket, and so on. Method 400 then ends in step 495.

In addition, it should be noted that although not specifically specified, one or more steps, functions or operations of the method 300 or method 400 may include a storing, displaying and/or outputting step as required for a particular application. In other words, any data, records, fields, and/or intermediate results discussed in the respective methods can be stored, displayed and/or outputted to another device as required for a particular application. Furthermore, steps or blocks in FIGS. 3 and 4 that recite a determining operation or involve a decision do not necessarily require that both branches of the determining operation be practiced. In other words, one of the branches of the determining operation can be deemed as an optional step. In addition, one or more steps, blocks, functions, or operations of the above described method 300 or method 400 may comprise optional steps, or can be combined, separated, and/or performed in a different order from that described above, without departing from the example embodiments of the present disclosure. However, the use of the term “optional step” is intended to only reflect different variations of a particular illustrative embodiment and is not intended to indicate that steps not labelled as optional steps to be deemed to be essential steps.

Furthermore, the capturing and dissemination of any of the captured video, audio, and/or other context data are only performed in full compliance with the pertinent privacy rules and policies that are in effect at the time. In other words, the captured likenesses, identities, personal information, and so forth of any individuals would only be done with the permission of the individuals (e.g., opting-into a service with full notice of the potential actions of capturing and dissemination of such data) or as permitted by law. In other words, the users of the present disclosure must authorize the usage of the users' context data by the service provider. For example, the present methods can be implemented as a subscribed service where the users are authorizing the processing system to utilize the received user context data for the benefit of the users. Namely, the subscribed service can be perceived as a network based concierge service deployed on an application server within the network and is trained and customized via machine learning for providing a connected context based concierge experience to a user during a traveling event.

FIG. 5 depicts a high-level block diagram of a computing device or processing system specifically programmed to perform the functions described herein. As depicted in FIG. 5, the processing system 500 comprises one or more hardware processor elements 502 (e.g., a central processing unit (CPU), a microprocessor, or a multi-core processor), a memory 504 (e.g., random access memory (RAM) and/or read only memory (ROM)), a module 505 for providing a connected context based concierge experience to a user during a traveling event, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 506 may also include antenna elements, transceivers, power units, and so forth. Although only one processor element is shown, it should be noted that the computing device may employ a plurality of processor elements. Furthermore, although only one computing device is shown in the figure, if the method 300 or method 400 as discussed above is implemented in a distributed or parallel manner for a particular illustrative example, i.e., the steps of the above method 300 or method 400, or the entire method 300 or method 400 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 502 can also be configured or programmed to cause other devices to perform one or more operations as discussed above. In other words, the hardware processor 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 300 or method 400. In one example, instructions and data for the present module or process 505 for providing a connected context based concierge experience to a user during a traveling event (e.g., a software program comprising computer-executable instructions) can be loaded into memory 504 and executed by hardware processor element 502 to implement the steps, functions, or operations as discussed above in connection with the illustrative method 300 or method 400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 505 for providing a connected context based concierge experience to a user during a traveling event (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
detecting, by a processing system comprising at least one processor, a start of a traveling event for a user;
establishing, by the processing system, a first context data sharing community for the traveling event, wherein the first context data sharing community comprises at least one context data source device and a plurality of service agents, where each of the plurality of service agents is expected to provide at least one service to the user for a duration specified for the traveling event;
determining, by the processing system, at least one recommendation or at least one action from context data associated with the user received from the at least one context data source device, wherein the context data comprises a purpose of the user for the traveling event; and
providing, by the processing system, the at least one recommendation to at least one service agent of the plurality of service agents for presentation to the user.

2. The method of claim 1, further comprising:
implementing, by the processing system, the at least one action on behalf of the user.

3. The method of claim 1, further comprising:
providing, by the processing system, a first portion of the context data to the plurality of service agents.

4. The method of claim 3, wherein the establishing further comprises setting a permission level for each of the plurality of service agents, wherein the providing the first portion of the context data to the plurality of service agents is based on the permission level for each of the plurality of service agents.

5. The method of claim 1, wherein the processing system is granted a consent by at least one owner of the at least one context data source device to store the context data.

6. The method of claim 5, wherein the processing system is further granted a consent by the user to store the context data.

7. The method of claim 5, further comprising:
creating an event type template in accordance with the consent from the at least one owner to share the context data in connection with the traveling event.

8. The method of claim 5, wherein the consent establishes at least one of:
at least one trigger condition for the start of the traveling event;
a duration of time for which the context data is shareable by the plurality of service agents; or
one or more data fields of the context data which are accessible by the plurality of service agents.

9. The method of claim 8, wherein the consent further establishes at least one of:
at least one retention time period for retaining the context data; or
an expiration condition for the first context data sharing community.

10. The method of claim 1, wherein the at least one context data source device comprises a plurality of context data source devices, wherein each of the plurality of context data source devices provides a separate context data set of the context data, and wherein each of the separate context data sets is accessible to a respective owner of a plurality of owners of the plurality of context data source devices and is inaccessible to others of the plurality of owners.

11. The method of claim 10, wherein the plurality of context data source devices comprises:
at least one video source device;
at least one audio source device;
at least one image source device; or
at least one sensor device.

12. The method of claim 3, wherein the providing further comprises:
anonymizing the first portion of the context data.

13. The method of claim 12, wherein the first portion of the context data comprises a still image or a video, wherein the anonymizing comprises:
obfuscating at least a portion of the still image or the video.

14. The method of claim 1, further comprising:
establishing, by the processing system, a second context data sharing community for the traveling event, wherein the second context data sharing community comprises at least one second service agent; and
providing, by the processing system, a second portion of the context data only to the at least one second service agent, where the at least one second service agent is expected to provide at least one service to the user for the duration of the traveling event.

15. The method of claim 3, further comprising:
receiving from one of the plurality of service agents, a request for a second portion of the context data;
verifying a condition for providing the second portion of the context data; and
providing the second portion of the context data to the one of the plurality of service agents in response to the verifying the condition.

16. The method of claim 15, wherein the second portion of the context data is not shareable at a time of the providing the first portion of the context data.

17. The method of claim 15, wherein the condition comprises receiving an affirmation from the one of the plurality of service agents of an emergency situation.

18. The method of claim 1, wherein the determining employs machine learning in determining the at least one recommendation or the at least one action from the context data associated with the user.

19. A non-transitory computer-readable medium storing instructions which, when executed by a processing system including at least one processor, cause the processing system to perform operations, the operations comprising:
detecting a start of a traveling event for a user;
establishing a first context data sharing community for the traveling event, wherein the first context data sharing community comprises at least one context data source device and a plurality of service agents, where each of the plurality of service agents is expected to provide at least one service to the user for a duration specified for the traveling event;
determining at least one recommendation or at least one action from context data associated with the user received from the at least one context data source device, wherein the context data comprises a purpose of the user for the traveling event; and
providing the at least one recommendation to at least one service agent of the plurality of service agents for presentation to the user.

20. A device comprising:
a processing system including at least one processor; and
a computer-readable medium storing instructions which, when executed by the processing system, cause the processing system to perform operations, the operations comprising:
detecting a start of a traveling event for a user;
establishing a first context data sharing community for the traveling event, wherein the first context data sharing community comprises at least one context data source device and a plurality of service agents, where each of the plurality of service agents is expected to provide at least one service to the user for a duration specified for the traveling event;
determining at least one recommendation or at least one action from context data associated with the user received from the at least one context data source device, wherein the context data comprises a purpose of the user for the traveling event; and
providing the at least one recommendation to at least one service agent of the plurality of service agents for presentation to the user.
